(19) United States
(12) Patent Application Publication
(10) Pub. No.: US 2004/0157197 A1
(43) Pub. Date: Aug. 12, 2004

(54) Educational arithmetic calculation game using specialized dice

(76) Inventor: Edward Hepner, Bronxville, NY (US)

Correspondence Address: JOSEPH FRANCIS MURPHY, 101 WEST 23RD STREET, SUITE 2367, NEW YORK, NY, 10011, US

(21) Appl. No.: 10/364,222

(22) Filed: Feb. 11, 2003

(51) Int. Cl. G09B 19/02; G09B 23/02

(52) U.S. Cl. 434/191

(57) ABSTRACT

An educational mathematical game using specialized dice, substantially as disclosed herein.

### TECHNICAL FIELD

This invention relates to games in general, and more specifically to games involving the use and application of arithmetical skill, and still more specifically to games involving the use of dice.

### BACKGROUND OF THE INVENTION

Learning basic arithmetic skill is essential to elementary education. Children must learn addition, subtraction, multiplication and division. Yet children are reluctant to learn these, often owing to the perceived tedium of performing computations for no apparent reason. Educational theorists have known that one of the best ways to learn a skill—such as arithmetic computation—is to use it repeatedly—e.g. to perform arithmetic computations repeatedly. While most children are not known to want to perform computations repeatedly, most children are known to often want to perform games repeatedly. Therefore, an invention which is in the form of a game and which requires the players to perform arithmetic computations is quite desirable.

### PRIOR ATTEMPTS TO SOLVE PROBLEM

Prior attempts to solve this problem have proven unsatisfactory. For example, consider some common approaches of the prior art.

One approach is to require children to compute sums and differences, and memorize multiplication tables. Another is to provide rudimentary games involving simple calculations with low value integers (e.g. such as those indicated on standard cubical dice) involved; the educational value of these games is limited. None of the known games of the prior art provide the particular advantages of the present invention.

### OBJECTS OF THE INVENTION

It is an object of the present invention to provide an entertaining and educational way for children to perform arithmetic computations in the context of a game.

It is yet another object of the present invention to provide such a game wherein skill, not just chance, significantly affects the outcome.

The foregoing and other objects of the invention are achieved by the method according to the current invention.

### BRIEF DESCRIPTION OF THE DRAWING

FIG. 1 is a view of a first exemplary playing board in accordance with the presently preferred embodiment of the present invention,

FIG. 2 is a view of a second exemplary playing board in accordance with the presently preferred embodiment of the present invention, and;

FIG. 3 is a view of a third exemplary playing board in accordance with the presently preferred embodiment of the present invention, and;

FIG. 4 is a view of a fourth exemplary playing board in accordance with the presently preferred embodiment of the present invention, and;

FIG. 5 is a view of a fifth exemplary playing board in accordance with the presently preferred embodiment of the present invention, and;

FIG. 6 is a view of a sixth exemplary playing board in accordance with the presently preferred embodiment of the present invention, and;

FIGS. 7 A-E is a view of exemplary playing markers which may be used with the presently preferred embodiment of the present invention, and;

FIGS. 8A-F is a view of exemplary specialized dice which may, in the presently preferred embodiment of the present invention, be used with the playing board of FIGS. 1-6, respectively.

### DETAILED DESCRIPTION OF THE PRESENTLY PREFERRED EMBODIMENT

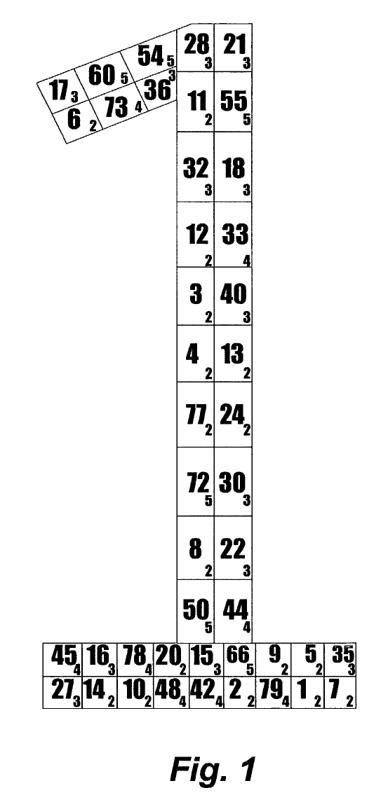

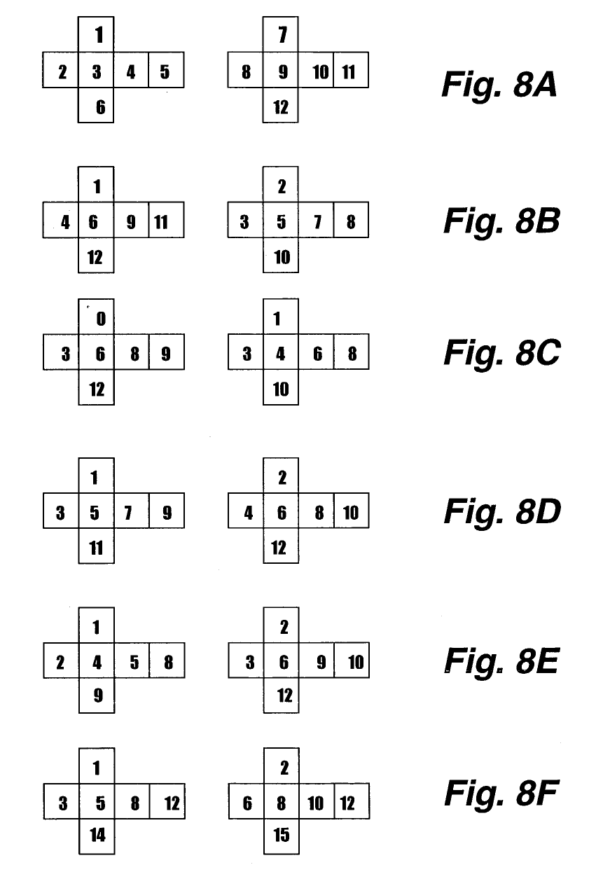

Reference is now made to FIG. 1, depicting the first exemplary game playing board in accordance with the present invention, e.g. a game board with a marked playing surface enclosing a bounded area, said bounded area being subdivided into a plurality of playing cells, each cell being suited for covering with a playing marker, and each cell being labeled with playing cell indicia comprising an integer. Note that, in connection with FIG. 1, there are provided a pair of green dice, with each die in the shape of a cube. The first die has on its six sides the following numbers: 1, 2, 3, 4, 5 and 6; the second die has on its six sides the following numbers: 7, 8, 9, 10, 11 and 12. The sides of these dice are depicted in a flattened view in FIG. 8A.

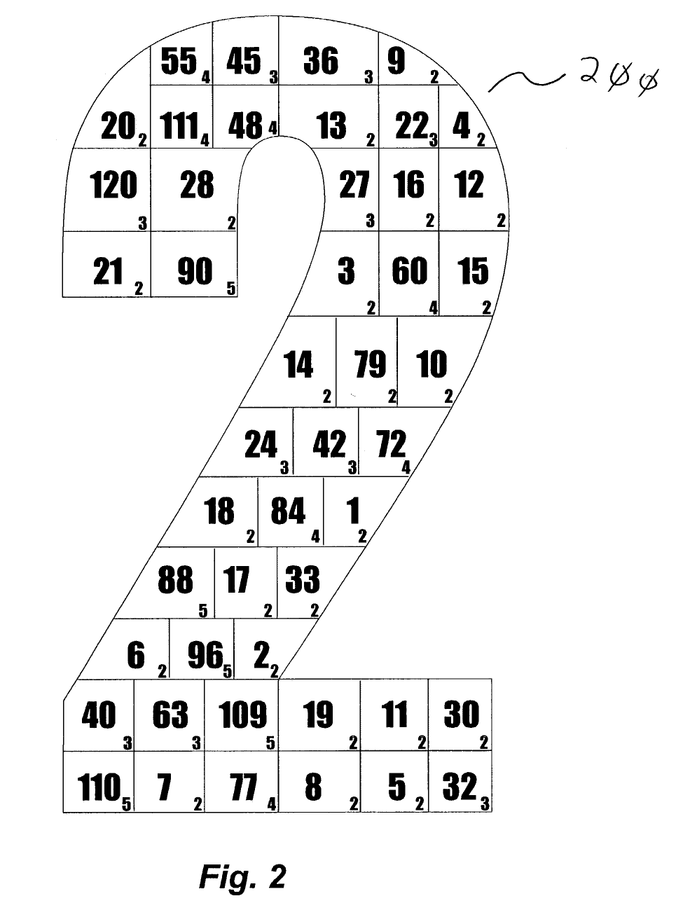

Reference is now made to FIG. 2, depicting the second exemplary game playing board in accordance with the present invention, e.g. a game board with a marked playing surface enclosing a bounded area, said bounded area being subdivided into a plurality of playing cells, each cell being suited for covering with a playing marker, and each cell being labeled with playing cell indicia comprising an integer. Note that, in connection with FIG. 2, there are provided a pair of red dice, with each die in the shape of a cube. The first die has on its six sides the following numbers: 1, 4, 6, 9, 11 and 12; the second die has on its six sides the following numbers: 2, 3, 5, 7, 8 and 10. The sides of these dice are depicted in a flattened view in FIG. 8B.

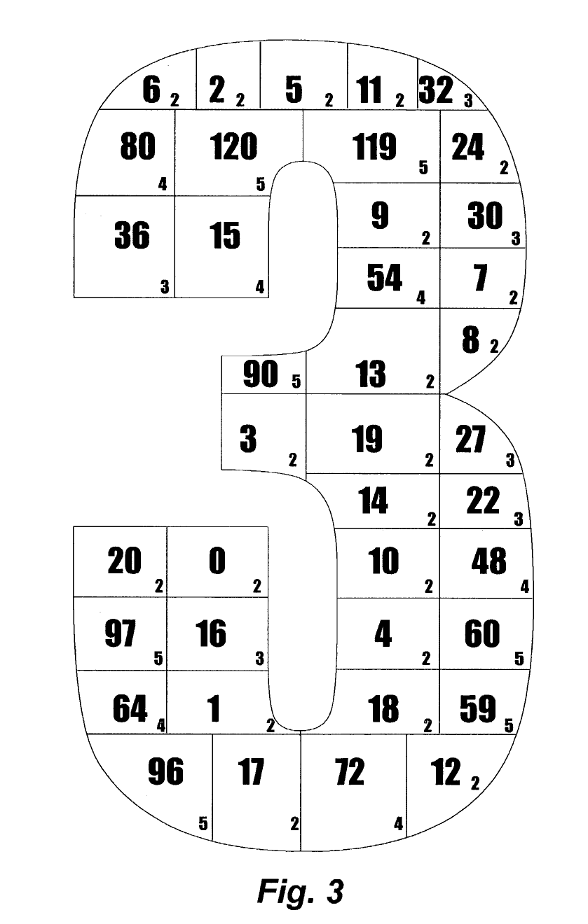

Reference is now made to FIG. 3, which depicts the third exemplary game playing board in accordance with the present invention, e.g. a game board with a marked playing surface enclosing a bounded area, said bounded area being subdivided into a plurality of playing cells, each cell being suited for covering with a playing marker, and each cell being labeled with playing cell indicia comprising an integer. Note that, in connection with FIG. 3, there are provided a pair of orange dice, with each die in the shape of a cube. The first die has on its six sides the following numbers: 0, 3, 6, 8, 9 and 12; the second die has on its six sides the following numbers: 1, 3, 4, 6, 8, and 10. The sides of these dice are depicted in a flattened view in FIG. 8C.

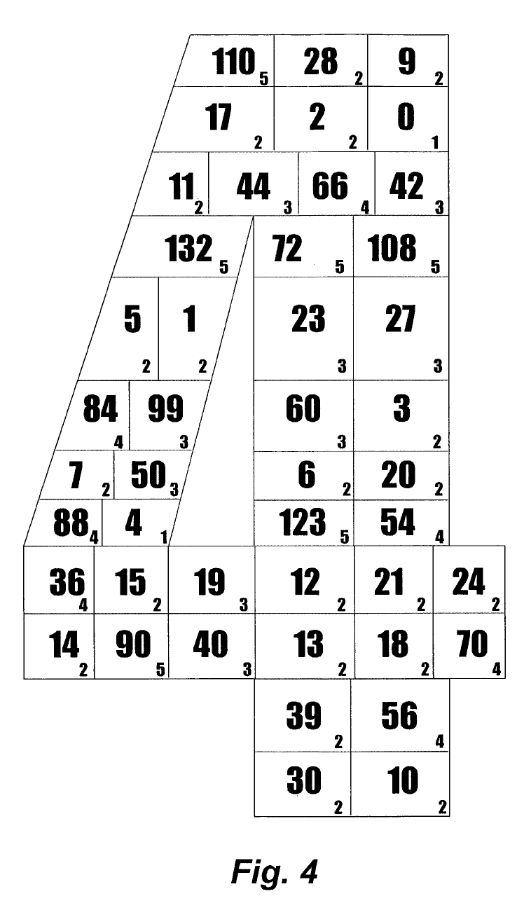

Reference is now made to FIG. 4, which depicts the fourth exemplary game playing board in accordance with the present invention, e.g. a game board with a marked playing surface enclosing a bounded area, said bounded area being subdivided into a plurality of playing cells, each cell being suited for covering with a playing marker, and each cell being labeled with playing cell indicia comprising an integer. Note that, in connection with FIG. 4, there are provided a pair of blue dice, with each die in the shape of a cube. The first die has on its six sides the following numbers: 1, 3, 5, 7, 9 and 11; the second die has on its six sides the following numbers: 2, 4, 6, 8, 10, and 12. The sides of these dice are depicted in a flattened view in FIG. 8D.

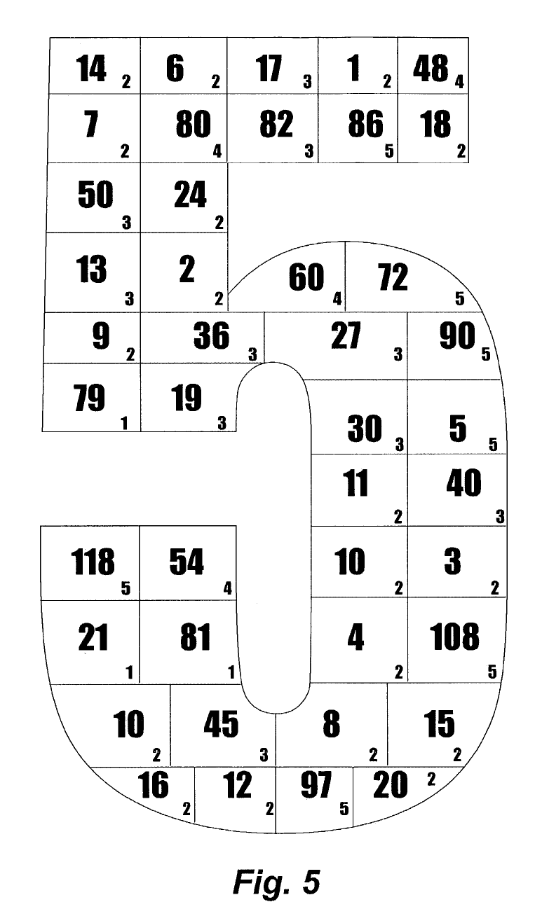

Reference is now made to FIG. 5, which depicts the fifth exemplary game playing board in accordance with the present invention, e.g. a game board with a marked playing surface enclosing a bounded area, said bounded area being subdivided into a plurality of playing cells, each cell being suited for covering with a playing marker, and each cell being labeled with playing cell indicia comprising an integer. Note that, in connection with FIG. 5, there are provided a pair of yellow dice, with each die in the shape of a cube. The first die has on its six sides the following numbers: 1, 2, 4, 5, 8 and 9; the second die has on its six sides the following numbers: 2, 3, 6, 9, 10 and 12. The sides of these dice are depicted in a flattened view in FIG. 8E.

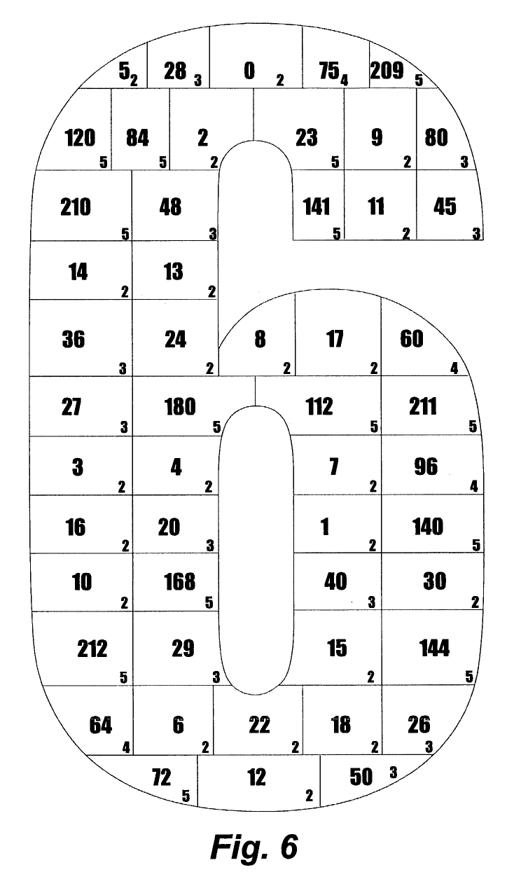

Reference is now made to FIG. 6, which depicts the sixth exemplary game playing board in accordance with the present invention, e.g. a game board with a marked playing surface enclosing a bounded area, said bounded area being subdivided into a plurality of playing cells, each cell being suited for covering with a playing marker, and each cell being labeled with playing cell indicia comprising an integer. Note that, in connection with FIG. 6, there are provided a pair of purple dice, with each die in the shape of a cube. The first die has on its six sides the following numbers: 1, 3, 5, 8, 12 and 14; the second die has on its six sides the following numbers: 2, 6, 8, 10, 12 and 15. The sides of these dice are depicted in a flattened view in FIG. 8F.

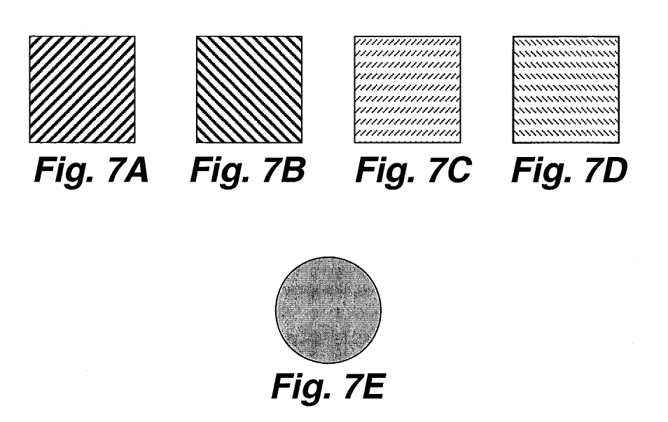

Reference is now made to FIG. 7, which depicts in FIGS. 7A-7E the game playing markers in accordance with the present invention. In this exemplary, presently preferred embodiment, FIGS. 7A-E depict the unique playing markers, which are of four unique colors (e.g. red, blue, green, yellow) (as indicated by the shading) with each color corresponding to an individual player. Note that each is of a different color, as indicated by the shading in FIGS. 7A-D. Each of said plurality of players is, prior to beginning play, supplied with an adequate supply (e.g. thirty or so) of his or her own color playing markers; these colors do not correspond either to board or dice color, merely to a particular player. FIG. 7E depicts another type of playing marker, i.e. the bonus playing marker; it is rendered in black, as indicated by the shading in FIG. 7E. A sufficient quantity of these, e.g. ten or so, is given to each player prior to beginning play.

Reference is now made to FIGS. 8A-F, which are views of exemplary specialized dice which may be used with the presently preferred embodiment of the present invention.

Referring again to FIGS. 1-6 and to FIG. 8A-8F, note that each of the six playing board surfaces is, in the presently preferred embodiment, made of a different color, each color playing board surface having a corresponding pair of dice in the corresponding color. Of course, these colors have been chosen essentially arbitrarily, and it will be readily apparent to those of ordinary skill in the relevant arts that other color combinations could additionally or alternatively be used. Each of the six pair of dice (at least some of which have on at least one face a number higher than six, which is the highest number found on a standard game die) has its own set of unique numbers, with a one-to-one correspondence existing between set B, the set of all integers in the playing cells on a given colored board and the “Answer Key”, i.e. set A, i.e. the [(super)set containing all possible “calculated solution sets” Sₙ, for all given Generated Integer sets Gₙ, that is, all solutions which could be arithmetically calculated (i.e. calculated via addition subtraction, multiplication, and division) from all possible combination of integers generated by rolling the corresponding colored dice. Note that while, in the presently preferred embodiment, certain numbers have been utilized, others could be substituted both for variety and for specific numerical instructional purposes. For example, one might instead have specific types of numbers, e.g. numbers divisible by five, or prime numbers, etc. Indeed, “customer-selected” numbers which a particular student might be having trouble with, due, for example, to a learning disability such as dyscalculia, could be used; the boards and dice would of course be modified so as to have the necessary correspondence between set A and set B.

While the present application, for exemplary purposes, uses decimal numbers, it is readily apparent to those of ordinary skill in the relevant arts that this game is not limited to decimal (base-ten) numbers, as it could be readily implemented so as to involve calculations and/or conversions in alternate number systems, e.g. hexadecimal (base-16) or binary (base-2) etc. However, for explanatory purposes decimal (base-10) numbers are used throughout this application, it being understood that these are used in a non-limiting sense).

It should be noted that the playing board shapes and configurations shown herein are also merely exemplary, and may be changed for variety, for other styles of play, or for other reasons, such as may be readily apparent to those of ordinary skill in the relevant arts. Moreover, although the indicia and other features used herein are primary visual in nature, it should be readily apparent to those of ordinary skill in the relevant arts that this game could be implemented in Braille or other tactile symbolic languages.

Reference is now made to FIG. 2 (200), which uses the “red set” of dice; this set includes a first red die with the numbers 1, 4, 6, 9, 11 and 12 written on its sides, and a second red die with the numbers 2, 3, 5, 7, 8 and 10 written on its sides. (Note that, while FIG. 2 is used extensively herein for exemplary purposes, the discussion with respect to FIG. 2 is equally applicable to the boards depicted in the other FIGS., and/or their equivalents.) Given every possible combination that can is be derived from the roll of these two dice (i.e. every possible set Gₙ of generated integers which can be generated from the roll of 2 dies), there are a total of 44 permissible different answers (i.e. answers in the form of positive integers) that can be made by adding, subtracting, multiplying, or dividing the values of each rolled die. To understand how, note that each different roll n of the dice generates a set Gₙ of generated integers comprising two integers (one on each die); these can be used to compute, via basic arithmetic operations, up to four or more possible answers. For instance, for a given roll (turn) n, e.g. the first roll (n=1), if the dice are rolled and a “4” and an “8” turn up, then those are the members of the set Gₙ of Generated Integers, which is denoted thusly: G₁,={4, 8}. A player may use these numbers with each of the four basic arithmetic operations (i.e. addition, subtraction, multiplication, and division) to produce the following four possible integer answers: (i) 12 (since 8+4=12); (ii) 12 (since 4+8=12); (iii) 4 (since 8−4=4), (iv) −4 (invalid result, since it is not a positive integer since 4−8=−4; (v) 32 (since 4×8=32); (vi) 32 (since 8×4=32); (vii) 2 (since 8/4=2); and (viii) (invalid result, since 4/8=0.5, which is not a positive integer) Thus, for that turn n, the Solution Set Sₙ may be computed and denoted thusly: Sₙ={12, 12, 4, 32, 32, 2}; since n=1 in this example, S₁={12, 12, 4, 32, 32, 2}. Eliminating duplicate members and listing the elements of the set in ascending order, S₁={2, 4, 12, 32}.

Note that, for each turn, the player must compute eight (8) mathematical operations, yielding up to four possible solutions together making up Solution Set Sₙ; the player must then determine if one or more elements of Sₙ corresponds to one or more uncovered playing cells. If so, it is likely that the player will then cover the playing cell bearing the highest point value (indicated in small font in the corner of the cell); with his or her marker; this choice, and how and why it is based on the point value of the cell, is explained in further detail elsewhere herein. Of course, those of ordinary skill in the relevant arts will recognize that, in the present example, A={1, 2, 3, 4, 5, 6, 7, 8, 9, 10, 11, 12, 13, 14, 15, 16, 17, 18, 19, 20, 21, 22, 24, 27, 28, 30, 32, 33, 36, 40, 42, 45, 48, 55, 60, 63, 72, 77, 84, 88, 90, 96,110, 120}, and B={1, 2, 3, 4, 5, 6, 7, 8, 9, 10, 11, 12, 13, 14, 15, 16, 17, 18, 19, 20, 21, 22, 24, 27, 28, 30, 32, 33, 36, 40, 42, 45, 48, 55, 60, 63, 72, 77, 79, 84, 88, 90, 96, 109, 110, 111, 120}. (Note that 79, 109, and 111 are in set B but NOT in set A; this is because they are spurious answers, found on the board but not in the answer key, for reasons discussed elsewhere herein.)

Referring again to FIG. 2, note that the red board contains 47 playing cells; there is one playing cell for each of 44 possible answers that made be made by employing the four basic mathematical operations on all possible combinations of rolls of the red dice, and there are 3 additional playing cells which are not, repeat, not possible solutions, but are spurious answers, which represent traps for the unwary player and add further playing experience to the game. Note that each of these 47 playing cells has in its center a large font integer, which signifies the number of the playing cell, and also has in a corner a small font integer, which represents the “point value” gained by the player who, in the course of play, “captures” that cell and covers it up with one of his or her playing markers, as described elsewhere herein. Point values used in the game may be arbitrarily assigned and/or assigned to specific integers based on the frequency such integer is likely to arise in play, i.e. on probability theory and practice.)

Continuing to refer to FIG. 2, and using the present example, where Sₙ={2, 4, 12, 32}, one notes that the playing cell marked “2” has a point value of “2”; the playing cell marked “4” has a point value of “2”; the playing cell marked “12” has a point value of “2”; the playing cell marked “32” has a point value of “3”. Thus, the player will preferably place his or her uniquely colored playing marker on the playing space labeled with the integer “32”, if that space has note yet been covered (played) since that space will net him or her the highest point value. If the playing space labeled “32” has already been covered, then the player may cover any of the other three spaces, i.e. those labeled 2, 4, or 12. If all of those spaces have been covered, then the player has no scoring move, and must take a black bonus playing marker (depicted in FIG. 7E) and place it so as to cover any remaining playing space on the board. Doing so ends his or her turn, and play passes to the next player.

The next player then takes the die and repeats the steps previously mentioned, and play passes from one player to the next, preferably clockwise, until the entire board is covered with playing markers, at which point each player calculates the sum of the point values under the playing cells covered by his or her markers; it should be understood that playing cells covered by the black bonus markers do not count towards any score. (Alternatively, or additionally, running totals of each player's scores could be kept, which will add to the strategic and competitive nature of the game.) The player with the highest point value is the winner; any tie(s) is/are broken by declaring as winner the tied player who had covered the largest integer in the course of play.

Note that the game set may also include a numerical solutions list (e.g. answer key) with the answers for each and every potential computations; this list is not to be used in the routine course of play, but only to check one player's calculation if it is disputed by another player. When such a disputation occurs, the player making the disputation will lose his or her turn if the calculation, upon being checked against the solutions list, is found to be correct. Alternatively, the player whose calculation was disputed will lose his or her turn if the calculation, upon being checked against the solutions list, is found to be incorrect.

It should be appreciated that the game disclosed in accordance with the method of the present invention, with its specialized dice, spurious values on some playing cells, disputation procedure, etc. is especially efficacious. It provides enhanced incentive for players to check both their own answers and those of the other players; furthermore, players are penalized for incorrect answers, not merely rewarded for correct ones. This is due to basic psychology, which, as is known to those of ordinary skill in the relevant art, has shown that behavior (in this case, arithmetic performance) is most effectively modified by the use of both positive reinforcement and negative reinforcement, and not of either form of reinforcement alone.

Note that, while the playing board of FIG. 2 has been most extensively discussed herein, that has been in an exemplary, non-limiting sense, and one of ordinary skill in the relevant art will appreciate that the references to FIG. 2, and the points made herein, apply with respect to any playing board depicted in any of FIGS. 1-6, and/or to any similar or equivalent playing board.

The presently preferred embodiment of the present invention is specifically illustrated and described herein. However, it will be appreciated that modifications and variations of the present invention are covered by the above teachings and are within the scope of the appended claims without departing from the spirit and intended scope of the invention.

What is claimed is:

1. A method for a plurality of players, each having a sufficient quantity of unique playing markers, to play by sequential turns an arithmetic game using said unique playing markers, dice and a game board with a marked playing surface enclosing a bounded area, said bounded area being subdivided into a plurality of playing cells, each cell being suited for covering with a playing marker, and each cell being labeled with playing cell indicia comprising an integer, said method comprising the steps of having, in turn, each of said plurality of players:
(a) roll said dice so as to generate a set of integers, said set of generated integers comprising the integers marked upon the topmost face of each of said die after it has been rolled;
(d) calculate a solution set of results from said set of generated integers, said calculated solution set containing all possible results obtaining from performing all possible arithmetic operations between each member of said set of generated integers, and
(e) choosing from said solution set one of said integers labeled on said board,
(f) indicating on said game board the one of said plurality of playing cells which is labeled with an integer corresponding to said chosen integer,
(g) having the order of play pass to the next in sequence player of said plurality of players, and repeating steps (a)—(f) for each player until all of said playing cells labeled with an integer has been covered.

2. A method as claimed in claim one, wherein said playing cell indicia further comprises a score.

3. A method as claimed in claim one wherein said plurality of players, also each has a sufficient quantity of bonus playing markers.
